(19) United States
(12) Patent Application Publication
(10) Pub. No.: US 2023/0315384 A1
(43) Pub. Date: Oct. 5, 2023

(54) SAFE VOICE-BASED REMOTE CONTROL OF A DOMESTIC APPLIANCE

(71) Applicant: BSH Hausgeräte GmbH, München (DE)

(72) Inventors: Andrea Etzbach, München (DE); Stefano Frattesi, München (DE); Wiebke Schmietendorf, München (DE); Desmond Wong, Traunstein (DE)

(21) Appl. No.: 18/004,093

(22) PCT Filed: Jun. 22, 2021
(86) PCT No.: PCT/EP2021/066939

§ 371 Date: Jan. 3, 2023

(30) Foreign Application Priority Data
Jul. 3, 2020 (DE) 10 2020 208 345.2

(51) Int. Cl. G06F 3/16; H04L 12/28

(52) U.S. Cl. CPC G06F 3/167; H04L 12/2803; H04L 2012/2841; H04L 2012/285

(57) ABSTRACT

A method controls a domestic appliance by a user. The method includes the steps of detecting a voice command of the user; determining whether the user is in a predefined first region around the control device; determining whether the control device is located in a predefined second region around the domestic appliance; and controlling the domestic appliance as a function of the voice command.

The invention relates to the remote control of a household appliance by voice input. In particular, the invention relates to the safe voice-based remote control of a potentially hazardous household appliance.

A household appliance, for example an electric or gas-operated stove, can be controlled in a conventional manner by a user, for example by means of a control knob or a control button. The stove can convert large amounts of energy, so that it can be classified as a safety-relevant appliance which requires supervision by the user.

In a networked kitchen, a plurality of appliances or services can be controlled by a user. So that the user has their hands free for kitchen activities, a gesture control or voice control can be used. For example, the pages of a digital cookbook can be turned over by a gesture or an extractor hood can be switched on or off by means of voice command. A control of a safety-relevant household appliance by means of voice command is not permitted, however, since the user could transmit their voice to the stove via an acoustic remote connection, for example by means of a telephone or a device linked to the Internet. If a hazardous situation were to arise due to the operation of the stove, for example by fat being set on fire, the user could then not control or combat this hazardous situation.

An object of the present invention, therefore, is to provide improved technology for the safe remote control of a household appliance by voice command. The invention achieves this object by means of the subjects of the independent claims. The subclaims represent preferred embodiments.

According to a first aspect of the present invention, a method for controlling a household appliance by a user comprises steps for detecting a voice command of the user on a control apparatus; determining that the user is in a predetermined first region around the control apparatus; determining that the control apparatus is in a predetermined second region around the household appliance; and controlling the household appliance as a function of the voice command. In this case, in particular, the household appliance is controlled only as a function of the voice command when the user is in a predetermined first region around the control apparatus and the control apparatus is in a predetermined second region around the household appliance.

If it is ensured that the user is in the first predetermined region and the control apparatus is in the second predetermined region, it can be concluded therefrom that the user is in a further predetermined region around the household appliance. As a result, it can be determined that the user can supervise the household appliance and the voice control of the household appliance by the user can be permitted. Thus a control apparatus can be safely used for controlling the household appliance. The control apparatus can be connected to a wide area network such as the Internet or a telephone network without the operating safety of the household appliance for the user being reduced thereby. The control apparatus can be fixedly attached or provided to be mobile. In one embodiment, the control apparatus can be carried by the user. In a further embodiment, the control apparatus can be positioned, for example, in a space in which the household appliance is located.

It is preferred that the household appliance comprises a kitchen appliance. The household appliance can comprise, in particular, a cooking appliance such as a stove, an oven or a steam cooker. Generally, the household appliance is designed to convert energy in the region of ca. 5 KW or more. In this case, the household appliance can be fed from any energy sources, for example electrically or by means of fuel gas. The household appliance can be operated in a kitchen, in particular in a household.

In a particularly preferred embodiment, it is determined that a line of sight is present in the first region between the user and the control apparatus. For this determination, various alternative embodiments which can also be combined together are described hereinafter. In particular, when a further line of sight is present between the control apparatus and the household appliance, it can also be assumed therefrom that a line of sight is present between the user and the household appliance. A positioning of the control apparatus can be considered for this determination.

In one embodiment, the user is optically detected on the control apparatus. For example, an image or a video data stream of the user can be detected while the user provides the voice command. The video data stream can comprise a sound recording and it can be determined whether a movement of the mouth of the user corresponds to the recorded audio data. Thus it can be ensured that no other person than the detected user provides the voice command.

It is further preferred that the user is identified. The identification can take place, in particular, on the basis of the image or the video data stream of the user. In this case, in particular, a face of the user can be examined. Other optical features of the user can also be checked, for example their appearance, their shape, their size or the type or extent of their movements. The control of the household appliance can be limited to a predetermined user. One or more users can be predetermined for controlling the household appliance. If a voice command from a different person is established, the command can be ignored. In this manner, for example, an effective child safety measure can be implemented.

It is particularly preferred that it is determined that a line of sight is present between the user and the household appliance. The line of sight can be in a third region which comprises the user and the household appliance. The third region can also comprise the first and/or the second region. The presence of a line of sight can be determined on the basis of map information relative to the third region.

In a further embodiment, in the first region a gesture of the user is detected on the control apparatus. The gesture can comprise, in particular, a hand gesture or arm gesture. A head gesture, a foot gesture or a different gesture of the user which can be expressed physically are also possible. The gesture can be determined, for example, by means of an optical sensor, a capacitive sensor or an ultrasonic sensor. An optical scanning of the gesture, for example by means of an infrared sensor, is also possible. The sensor can be designed to provide an image of the person or merely scan a movement. It should be noted that the control apparatus itself can be controlled by means of gestures. A gesture identification can thus already be part of the control apparatus. A predetermined gesture can be related to the control apparatus or the household appliance, depending on the context or embodiment. For example, the gesture can be used in order to confirm the voice command of the user.

In a further embodiment, a position of the user in the first region is determined. The position can be determined relative to the control apparatus or further preferably relative to the household appliance. To this end, the person in the first region, for example, can be optically scanned by means of a radar sensor or lidar sensor. In further embodiments, a movement or a shape of the user can also be identified. The position of the user can be determined relative to a map of the surroundings in which a position of the household appliance can be indicated. The map of the surroundings can illustrate obstacles which can hinder or interrupt a line of sight to the household appliance. Information about the map of the surroundings, in particular a position of the household appliance or an obstacle, can originate from an external source or can be determined on the basis of sensor signals of the control apparatus or the household appliance.

Thus it can be determined whether or not an adequate line of sight is present between a specific position of the user and the position of the household appliance. Moreover, it can be determined whether an obstacle, which hinders the access of the person to the household appliance, is located between the positions, for example in order to avert hazardous situations. Such an obstacle can comprise, for example, a hatch or a closed glass door.

The position of the user can also be determined on the basis of acoustic information of the voice command. To this end, one or more microphones can be encompassed by the control apparatus. The microphones can be distributed in the first region. The position of the user can be determined, for example, by means of triangulation on the basis of the stereo effect.

In a further embodiment, a predetermined user can be identified on the basis of the voice command. To this end, in particular, a profile of the voice of the user can be compared with a stored profile. The profile can encompass, for example, a frequency distribution, a speech mannerism or an intonation.

It is generally preferred that the determination as to whether the user is in the first region or not is determined on the basis of various scans of different physical phenomena. Thus, for example, an optical and an acoustic scanning can take place and the scanning results can be compared with one another.

For determining whether the control apparatus is in the predetermined second region around the household appliance, it can be determined whether a line of sight is present between the control apparatus and the household appliance. To this end, a similar technique can be used to that described above relative to the position of the user in the first region. In a preferred embodiment, the line of sight is checked by means of a sensor, for example, in the manner of a light barrier.

In a further embodiment, it can be determined that a spacing between the control apparatus and the household appliance is below a predetermined distance. In this case, the household appliance is preferably controlled as a function of the voice command only when the spacing between the control apparatus and the household appliance is below the predetermined distance. Thus it is possible to prevent the user from being spaced too far apart from the household appliance as a whole in order to be able to supervise the household appliance in a meaningful manner.

In a further embodiment, which naturally can be combined with all of the other embodiments, the control apparatus and the household appliance are connected together by means of a wireless communication connection. The determination as to whether the control apparatus is in the second region can be carried out on the basis of a wireless communication signal transmitted between the control apparatus and the household appliance. The communication connection can comprise, in particular, electromagnetic signals and can be implemented, for example, according to a WLAN or Bluetooth standard, in particular by means of Bluetooth Low Energy (BLE). In this case, for example, a distance can be determined on the basis of the strength of the received communication signal. Some appliances also permit the determination of a direction of the communication partner. The determination of the direction and/or the determination of the strength of the received communication signal can be carried out by one or both communication partners. Preferably, however, the signal strength is determined and evaluated by the household appliance from where the hazardous situation originates and which is to be controlled by means of the voice command. In this manner, for example, it can be achieved that the household appliance, such as for example a stove, can be controlled via Bluetooth only when the control apparatus is sufficiently close to the household appliance. A corresponding indicator (Received Signal Strength Indictor, RSSI) can be already provided by a receiver as standard.

According to a second aspect of the present invention, a control apparatus for the safe control of a household appliance by a user comprises a detection facility for detecting a voice command of the user; and a determination facility for determining that the user is in a predetermined first region around the control apparatus. Moreover, the control apparatus is designed to control the household appliance as a function of the voice command if the control apparatus is in a second region around the household appliance.

The control apparatus can comprise a processing facility which is designed to carry out entirely or partially a method described herein. To this end, the processing facility can comprise a programmable microcomputer or microcontroller and the method can be in the form of a computer program product with program coding means. The computer program product can also be stored on a computer-readable data carrier. Features or advantages of the method can be transmitted to the control apparatus or vice versa.

The control apparatus can also be designed to determine whether it is in the second region around the household appliance. In a further embodiment, this determination can be carried out on the part of the household appliance.

According to a third aspect of the present invention, a system comprises a control apparatus described herein and a household appliance. In particular, the household appliance can be safety-relevant, for example in that it is able to convert large amounts of energy, and thus can represent a hazard within the household. The household appliance can comprise a kitchen appliance, in particular a cooking appliance, and is designed to be controlled by the control apparatus.

Embodiments of the invention are now described in more detail with reference to the accompanying figures, in which:

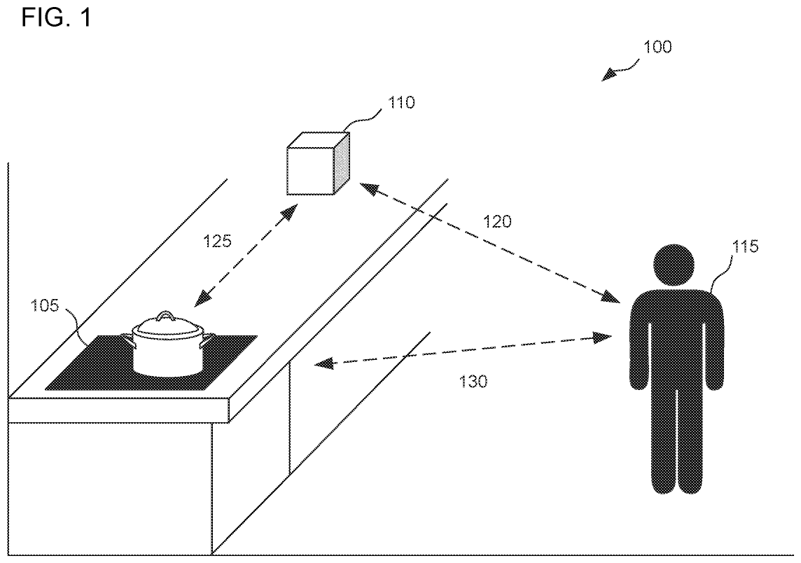

FIG. 1 shows a system;

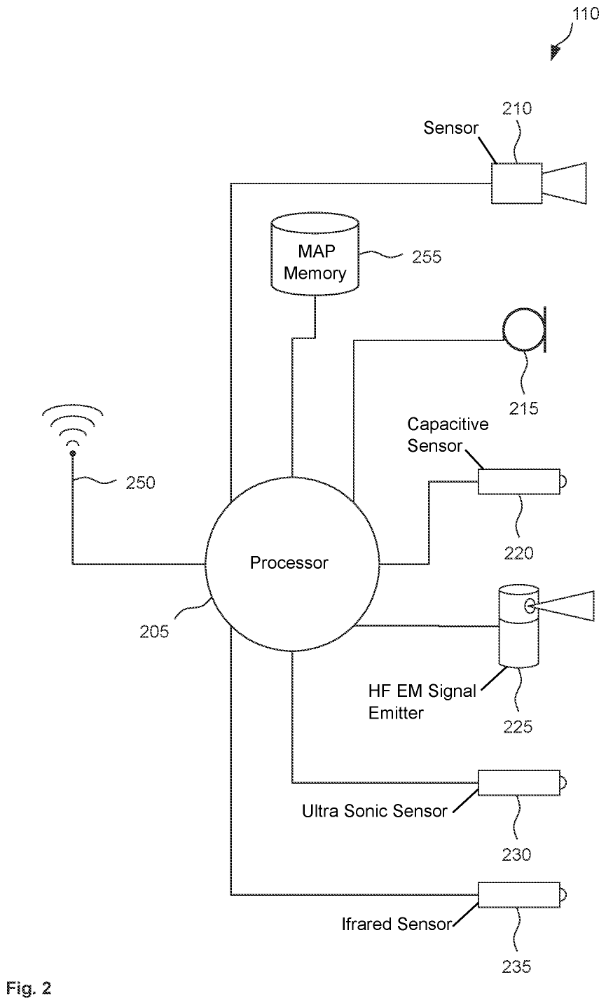

FIG. 2 shows a control apparatus for a household appliance; and

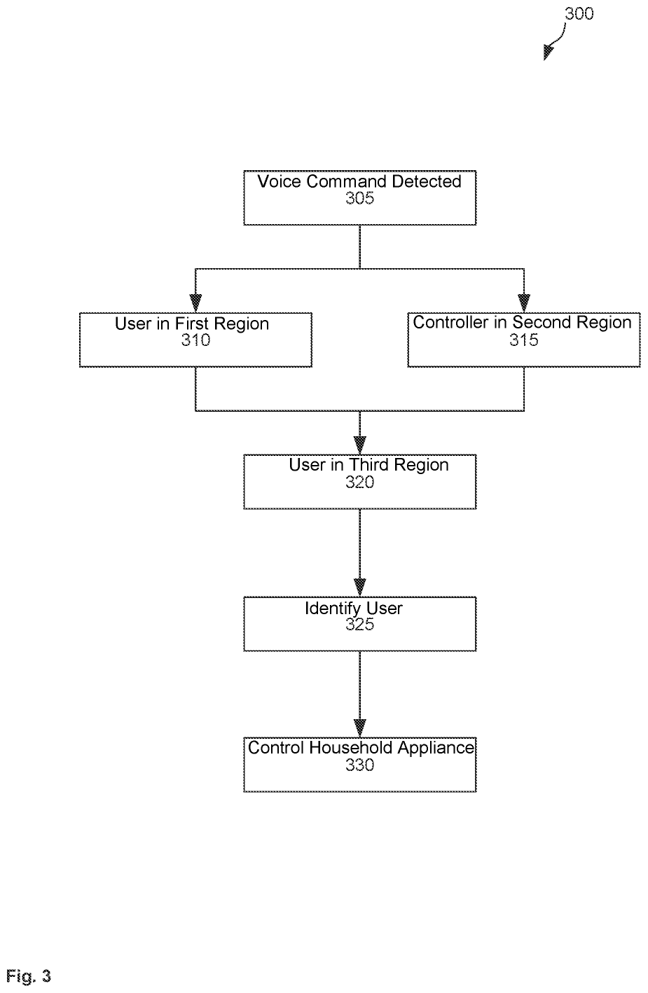

FIG. 3 shows a flow chart of a method.

FIG. 1 shows a system 100 which comprises a household appliance 105 and a control apparatus 110. The household appliance 105 can be remotely controlled by a user 115. In this case, the user 115 is generally located outside a physical range of a control element which acts directly on the household appliance 105. In the present case, the household appliance 105 is shown as a cooktop; in other embodiments a different household appliance can also be encompassed, in particular a household appliance which is regarded as safety-relevant. For example, the household appliance 105 can come under the regulations of EC 60335-2-6 2014 or DIN EN 30-1-1:2013-06. The household appliance 105, the control apparatus 110 and the user 115 are generally located in the same household, further preferably in the same space, in particular a kitchen.

The control apparatus 110 can comprise a mobile device such as a smartphone or a tablet computer or even a smart speaker or a smart display. The control apparatus 110 can be carried or, for example, held in the hands by the user 115. In a further embodiment, the control apparatus 110 is designed to be positioned, attached or deposited. For example, the control apparatus 110 can be deposited in the region of a shelf which is located in the vicinity of the household appliance 105. The control apparatus 110 can also comprise a dedicated technical facility which is designed, for example, for controlling a plurality of household appliances 105. The control apparatus 110 can carry out further functions, for example managing cooking recipes or displaying contents from the Internet.

The user 115 can include any person. In some embodiments, it can be checked whether the user 115 is authorized as a specified person and thus for controlling the household appliance 105. In a further embodiment, the control of the household appliance 105, for example, can be accessible to all persons 115 who are not determined as a child.

The user 115 is in a first predetermined region 120 around the control apparatus 110. At the same time, the control apparatus 110 is in a second predetermined region 125 around the household appliance 105. If the regions 120 and 125 are determined sufficiently accurately, then it can also be determined that the person 115 is in a third region 130 around the household appliance 105. In particular, it can be determined whether the user 115 has a line of sight to the household appliance 105. Thus it can be indirectly determined whether the user 115 is able to supervise the household appliance 105. In this case, the user can be permitted to control the household appliance 105 remotely. To this end, in particular, the user can give a voice command which is identified on the part of the control apparatus 110 or on the part of the household appliance 105 and can form the basis of the control of the household appliance 105.

FIG. 2 shows an exemplary schematic view of a control apparatus 110. The control apparatus 110 comprises a processing facility 205 which can be connected to different sensors. An exemplary first sensor 210 comprises a camera which, for example, can operate in the optical or in the infrared range. The camera 210 can be designed to record individual images or a video data stream. A second exemplary sensor comprises a microphone 215. The microphone 215 is designed to scan an acoustic expression of the person 115. A plurality of microphones 215 can also be provided. A microphone 215 can be attached directly to the control apparatus 110, to the household appliance 105, or to the user 115. Moreover, a microphone 215 can be positioned freely in a space which can include the regions 125 to 130. A microphone 215 can also be attached wirelessly to the control apparatus 110 and, for example, implemented as a headset or lavalier microphone of the user 115.

A third exemplary sensor 220 comprises a capacitive sensor which can comprise one or more electrodes. The capacitive sensor 220 can be designed, in particular, to identify gestures of the user 115. The sensor 220 can be activated by means of a direct voltage signal or an alternating voltage signal.

A fourth exemplary sensor 225 comprises a radar sensor or lidar sensor. Both sensors can be designed to emit a high-frequency electromagnetic signal and to determine the reflections thereof. In the case of the lidar sensor, generally a laser light beam is used therefor. The sensor 225 is preferably an imaging sensor and can provide, in particular, differentiated information about the distance from a detected object.

A fifth exemplary sensor 230 comprises an ultrasonic sensor which can be designed to determine a distance or a movement of an object. To this end, generally sound signals can be emitted in the non-audible range and the reflections thereof received.

A sixth exemplary sensor 235 comprises an infrared sensor which is preferably designed to detect a gesture of the user 115. The sensor 235 can have a limited range of, for example, ca. 1.5 m, ca. 1 m, ca. 0.8 m or ca. 0.5 m. If the user 115 is located further from the sensor 235 than has been predetermined, then the user cannot be identified.

In addition to the sensors 210 to 235, the control apparatus 110 can comprise a communication facility 250 which is designed for wireless communication with the household appliance 105. The communication facility 250 can operate, in particular, on the basis of Bluetooth, further preferably Bluetooth Low Energy (BLE). A distance between the control apparatus 110 and the household appliance 105 can be determined on the basis of signals which can be exchanged therebetween via the communication facility 250. A corresponding determination can also be carried out on the part of the household appliance 105.

Optionally a map memory 255 which is designed to record map information, which relates to a space which can comprise the regions 125 to 130, is provided. Information for the map memory 255 can come from an external source or from one or more of the sensors 215-235. If the household appliance 105, the control apparatus 110 and the user 115, for example, are located in a room of a household, the map information can relate to the room. Thus, for example, furniture and other obstacles, walls, doors or windows can be stored in the map information. On the basis of the map information it can be determined whether a line of sight can be established or not between two predetermined positions. Moreover, a geometric spacing between the positions can be determined and the length of a path that the user 115 has to cover from their current position in order to reach the household appliance 105 can be determinable. This path can be significantly longer than a line of sight to the household appliance 105.

FIG. 3 shows a flow chart of a method 300 for controlling a household appliance 105. The method 300 can be carried out, in particular, in combination with a system 100.

In a step 305 a voice command can be detected. The voice command can be output by the user 115 and, in particular, relate to a control of household appliance 105. In the case of a stove, for example, the voice command can relate to a selection of a hotplate and an absolute or relative setting of the heating of a pot on this hotplate.

In a step 310 it can be determined whether the user 115 is in a predetermined first region 120 around the control apparatus 110. To this end, the user 115 can be scanned and detected by means of one or more of the sensors 210 to 235. Sensor signals of the sensors 210 to 235 can be compared or combined with one another. If the signals of one of the sensors 210 to 235 indicate different circumstances from the others, the measurement can be discarded as inconclusive. In this step, the positions of the control apparatus 110 and/or the person 115 can also be determined. A spacing between the control apparatus 110 and the user 115 can also be determined on the basis of the positions, or directly.

In a step 315, which is preferably carried out at the same time or further preferably only after completing step 310, it can be determined whether the control apparatus 110 is within a second region 125 around the household appliance 105. This determination is preferably carried out on the basis of a communication connection between the control apparatus 110 and the household appliance 105. Positions of the control apparatus 110 and/or the household appliance 105 can also be determined in this step. A spacing between the appliances 105 and 110 can also be determined on the basis of the positions, or directly.

A step 320 is preferably carried out only when the steps 310 and 315 have been positively determined, i.e. the user 115 is in the first region 120 and the control apparatus 110 is in the second region 125. In this step it can be determined whether the user 115 is in the third region 130 around the household appliance 105. In particular, it can be determined whether a line of sight is present between the user 115 and the household appliance 105. Moreover, it can be determined how great a spacing is from the user 115 to the household appliance 105. Different spacings can relate to the length of a line of sight and the length of a path for the user 115 to the household appliance 105. These determinations can be carried out on the basis of previously determined positions of the household appliance 105 and the person 115, optionally with reference to a position of the control apparatus 110. For these determinations, it is possible to consider map information which can relate to physical obstacles or visible obstacles in the region of a space which can comprise the regions 120 to 130.

In an optional step 325 the user 115 can be identified. The identification can be carried out, in particular, on the basis of scans which have been carried out in step 310. The user 115 can also be identified on the basis of the voice command in step 305. In one embodiment, the user 115 can be identified by means of the voice command, for example on the basis of their voice pattern or on the basis of the spoken text. If it were to be determined that the user 115 is not permitted to control the household appliance 105, the method 300 can be interrupted at this point. In one embodiment, any person can be permitted to control the adoption of a safe state by the household appliance 105. The safe state can relate, in particular, to switching off the household appliance 105. In particular, in the case of a cooking appliance, a lower energy state can also be activated. In this case, no more than a predetermined quantity of heat can be provided or a food to be cooked can be heated only to a predetermined temperature.

In a step 330 the household appliance 105 can be controlled as a function of the voice command of the user 115.

It should be mentioned that the steps 305 to 330 do not necessarily have to be carried out in the sequence shown. In other embodiments, for example, an identification of the user 115 can be carried out before it is determined whether the user 115 is in the first region 120 around the control apparatus 110.

### REFERENCE SIGNS

100 System
105 Household appliance
110 Control apparatus
115 User
120 First region
125 Second region
130 Third region
205 Processing facility
210 Camera
215 Microphone
220 Capacitive sensor
225 Radar sensor/lidar sensor
230 Ultrasonic sensor
235 Infrared sensor
250 Communication facility
255 Map memory
300 Method
305 Detect voice command
310 User in first region around control apparatus?
315 Control apparatus in second region around household appliance?
320 Line of sight between user and household appliance?
325 Identify user
330 Control household appliance

1-15. (canceled)

16. A method for a safe control of a household appliance by a user, wherein the method comprises the following steps of:
detecting a voice command of the user via a controller;
determining that the user is in a predetermined first region around the controller;
determining that the controller is in a predetermined second region around the household appliance; and
controlling the household appliance in dependence on the voice command.

17. The method according to claim 16, wherein the household appliance has a kitchen appliance.

18. The method according to claim 16, which further comprises determining if a line of sight is present in the predetermined first region between the user and the controller.

19. The method according to claim 18, which further comprises optically detecting the user via the controller.

20. The method according to claim 19, which further comprises identifying the user.

21. The method according to claim 16, which further comprises determining if a line of sight is present between the user and the household appliance.

22. The method according to claim 16, which further comprises detecting a gesture of the user in the predetermined first region via the controller.

23. The method according to claim 16, which further comprises determining a position of the user in the predetermined first region.

24. The method according to claim 23, which further comprises determining the position on a basis of acoustic information of the voice command.

25. The method according to claim 16, which further comprises identifying the user on a basis of the voice command.

26. The method according to claim 16, which further comprises determining whether a line of sight is present in the predetermined second region between the controller and the household appliance.

27. The method according to claim 16, which further comprises determining if a spacing between the controller and the household appliance is below a predetermined distance.

28. The method according to claim 26, which further comprises carrying out the determining step on a basis of a wireless communication signal transmitted between the controller and the household appliance.

29. A controller for a safe control of a household appliance by a user, the controller comprising:
a detector for detecting a voice command of the user; and
a determination facility configured to determine that the user is in a predetermined first region around the controller, wherein the controller is configured to control the household appliance in dependence on the voice command if the controller is in a predetermined second region around the household appliance.

30. A system, comprising:
said controller according to claim 29; and
a household appliance.
